(19) United States
(12) Patent Application Publication
(10) Pub. No.: US 2009/0080821 A1
(43) Pub. Date: Mar. 26, 2009

(54) PLAIN BEARING

(75) Inventors: Takashi ANDOU, Inuyama (JP); Atsushi Okado, Inuyama (JP); Masayuki Niwa, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: DAIDO METAL COMPANY LTD 13F, NAGOYA HIROKOJI BLDG, NAGOYA (JP)

(21) Appl. No.: 12/238,151

(22) Filed: Sep. 25, 2008

(30) Foreign Application Priority Data
Sep. 25, 2007 (JP) 2007-247006

(51) Int. Cl. F16C 9/02; B21D 53/10

(52) U.S. Cl. 384/294; 29/898.054

(57) ABSTRACT

A plain bearing capable of suppressing occurrence of bearing damage in a primary load portion is provided. The primary load portion in the center of at least one of the plain bearings that mainly receives load during rotation of a shaft is subjected to inner surface working by broaching so that roughness is 1 μm Rz or less, while a light load portion at 10° to 60° from a bearing mating surface of the plain bearing that receives load smaller than that received by the primary load portion is subjected to inner surface working of a circumferential fine groove by boring so that the depth is 1 μm to 15 μm.

### BACKGROUND OF THE INVENTION

1. Field of the Invention

The present invention relates to a plain bearing formed into a half-bearing shape, so that a cylindrical shape is configured by combining the two plain bearings.

2. Description of the Related Art

Conventionally, an inner surface of a plain bearing formed into a half-bearing shape for an internal combustion engine has been worked using a working method of either broaching or boring. Especially in recent years, it becomes common to form a plurality of streak grooves in a circumferential direction on the bearing inner surface by boring to enhance an oil retaining effect by streak recessed portions and enhance conformability by preferentially causing the tops of projected portions of the streaks to contact and wear against a shaft surface, as shown in JP-A-07-259858, for example. However, since the boring makes the pitch of the streak grooves wide and makes the grooves deep, the roughness of the bearing surface becomes high.

### BRIEF SUMMARY OF THE INVENTION

On the other hand, the lubrication mode of a plain bearing for an internal combustion engine is fluid lubrication in general by a lubricating oil film formed between the bearing and the shaft surface, however, with increase in output power and speed of an internal combustion engine, the thickness of the lubricating oil film becomes extremely thin, e.g. about 1 μm or less in a primary load portion of the bearing that receives load mainly. Therefore, when the roughness in the primary load portion of the inner circumferential surface of the bearing is large due to the boring as described in JP-A-07-259858, the height of the projected portions forming the streaks is larger than the minimum oil film thickness so that the tops of the projected portions inevitably contacts the shaft surface. Therefore, there arises the problem of causing bearing damage such as seizure and fatigue due to the contact which inhibits formation of the oil film.

The present invention is made in view of the above described circumstances, and an object thereof is to provide a plain bearing capable of suppressing generation of frictional damage in a primary load portion of the plain bearing.

Accordingly, the invention according to claim 1 is characterized in that, in a plain bearing formed into a half-bearing shape for configuring a cylindrical shape by combining the two plain bearings, a primary load portion in the center in a circumferential direction that mainly receives load during rotation of a shaft is formed on an inner surface of the plain bearing by inner surface working by broaching so that the roughness of the inner surface becomes 1 μm Rz or less, while a light load portion extending in the circumferential direction on each side of the primary load portion from a bearing mating surface toward the center by at least 10° and at most 60° that receives less load than the load received by the primary load portion is formed on an inner surface of the plain bearing (by inner surface working by boring for example) so that a circumferential fine groove having a depth of 1 μm to 15 μm is formed therein.

Further, the invention according to claim 2 is characterized in that, in the plain bearing according to claim 1, the inner surface working is performed so that the depth of the circumferential fine groove by the boring gradually decreases toward the center from the bearing mating surface.

In the invention according to claim 1, the inner surface of the primary load portion (center) of the plain bearing is subjected to the broaching so that the roughness of the bearing surface can be made substantially flat, i.e. 1 μm Rz or less which is smaller than the minimum oil film thickness. By making the roughness of the primary load portion small, oil film formation is not inhibited, and the shaft and the primary load portion of the plain bearing are hardly in metal contact with each other, which can prevent bearing damage such as seizure and fatigue Further, since the cutting resistance of the broaching is larger than that of the boring, and therefore work hardening is provided to a bearing alloy of the inner circumferential surface of the plain bearing, fatigue resistance of the bearing is also improved.

Meanwhile, by applying the boring to the light load portion (in the vicinity of the mating surface) which is not loaded relatively, the feeding amount of oil to the primary load portion side is increased by using the retaining effect of oil by the recessed portions of the circumferential fine groove to aid the oil film formation. The depth of the fine groove is 1 to 15 μm in consideration of retainability of oil. If the depth is less than 1 μm, the oil amount retained in the fine groove becomes small, and the feeding effect of oil to the primary load portion decreases. In addition, if the depth exceeds 15 μm, the loading capacity of the light load portion becomes low, and the light load portion is easily worn.

In addition, in the invention according to claim 2, by applying the inner surface working so that the depth of the circumferential fine groove by the boring gradually decrease toward the center from the bearing mating surface, continuous oil flow is formed, and lubricant oil is easily fed to the center of the plain bearing, which is more effective.

As described above, since it has been considered that the conformed surface naturally formed by wear of the bearing sliding surface is the best way to prevent seizure of the plain bearing, the surface roughness larger than the minimum oil film thickness is provided conventionally. However, by the feeding effect of oil to the central portion of the bearing by the circumferential fine groove formed in the vicinity of the mating surface of the plain bearing, and the effect of facilitating oil film formation by flattening of the primary load portion (central portion), it becomes possible to reduce friction loss of the internal combustion engine. In the same manner as the conventional plain bearing, the thickness of the plain bearing may be made uneven so as to gradually decrease toward an end portion from the central portion in the bearing circumferential direction, and crush relief may be formed at the end portion in the bearing circumferential direction. In the case of the one for an internal combustion engine with a large bending amount of the shaft, both end portions in the bearing width direction may be subjected to forming relieve.

### BRIEF DESCRIPTION OF THE SEVERAL VIEWS OF THE DRAWINGS

FIG. 1 is a schematic side view of a plain bearing.

### DETAILED DESCRIPTION OF THE INVENTION

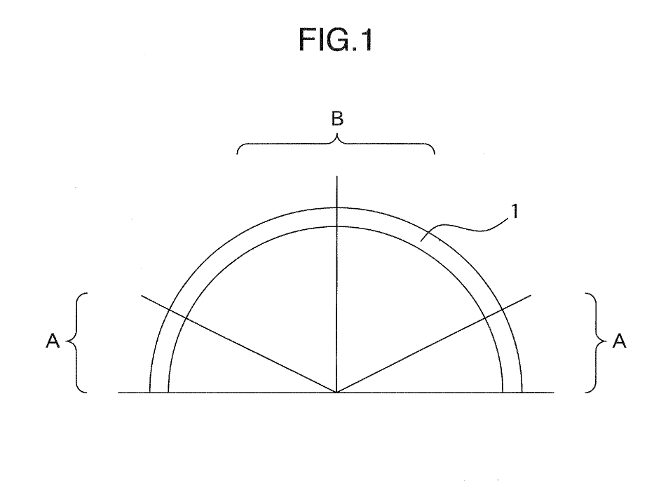

Hereinafter, an embodiment of the present invention will be described with reference to FIG. 1. FIG. 1 is a schematic side view of a plain bearing 1. As shown in FIG. 1, the plain bearing 1 according to the present embodiment is formed into a half-bearing shape, and two of the plain bearings 1 are combined to configure a cylindrical shape so as to support a shaft (not illustrated) rotatably. An inner circumferential surface of the plain bearing 1 is lined with a bearing alloy such as a Cu-base alloy, an Al-base alloy, a Sn-base alloy and a Pb-base alloy in order to satisfy bearing properties of the plain bearing 1 such as anti-seizure property, and an overlay layer made from a Sn-base or Pb-base alloy, or a synthetic resin-base overlay layer is formed if necessary. By forming the overlay layer, sliding properties of the plain bearing 1 can be improved.

When manufacturing the plain bearing 1 shown in FIG. 1, first, a multi-layer slide member in which a Cu bearing alloy or Al bearing alloy is formed on steel is cut into a flat plate having a predetermined dimension. Then, it is formed into a half-bearing forming by press working. Then, chamfering is applied to an outer circumference and an inner circumference of both ends in a width direction of the bearing. Then, it is cramped with a jig, and turning is applied to light load portions (portions A in FIG. 1) which are bearing end portions by a boring machine to form a fine groove having a depth of 1 to 15 μm in the circumferential direction of the plain bearing. Thereafter, cutting is applied to a primary load portion (portion B in FIG. 1) which is a bearing central portion by a broach blade, so that the roughness of an alloy surface of the bearing at the central portion is 1 μm Rz or less. The order of the boring and the broaching may be alternated. In the following description, the primary load portion will be expressed as a bearing central portion, and the light load portion will be expressed as a bearing end portion.

The plain bearings 1 having a halfbearing shape of examples 1 to 3 and comparative examples 1 to 3 which are worked in the above mariner so that the roughness in the bearing central portions and the depth of the fine grooves in the bearing end portions differ from each other (while comparative example 1 is subjected only to boring, and comparative example 2 is subjected only to broaching) are paired into a cylindrical shape, and a friction wear test is performed with a dynamic load bearing testing machine under the conditions shown in Table 1.

TABLE 1

| | |
|---|---|
| BEARING SIZE | OUTSIDE DIAMETER φ55 mm × WIDTH |
| | 17 mm × THICKNESS 1.5 mm |
| TESTING MACHINE | DYNAMIC LOAD BEARING TESTING |
| | MACHINE |
| SPECIFIC LOAD | 70 MPa |
| PERIPHERAL VELOCITY | 10 m/s |
| LUBRICATION METHOD | FORCED LUBRICATION |
| OIL SUPPLY PRESSURE | 100° C. |

In example 1, first, a multi-layer slide member in which an Al alloy bearing is formed on steel is cut into a flat plate having a predetermined dimension. Then, it is formed into a half-bearing formation by press working Then, chamfering is applied to an outer circumference and an inner circumference of both ends in a width direction of the bearing Then, it is cramped with a jig, and turning is applied to bearing end portions by a boring machine to form a fine groove having a depth of 5 μm in the circumferential direction of the plain bearing Thereafter, cutting is applied to the bearing central portion by a broach blade, so that the roughness of the bearing alloy surface at the central portion is 0.8 μm Rz. The area of the fine groove in the circumferential direction of the plain bearing is a 30° area from mating surfaces at both ends of the bearing.

In example 2, first, the multi-layer slide member in which the Al alloy bearing is formed on steel is cut into the flat plate having the predetermined dimension. Then, it is formed into the half-bearing formation by press working. Then, chamfering is applied to the outer circumference and the inner circumference of both ends in the width direction of the bearing. Then, it is cramped with a jig, and turning is applied to the bearing end portions by a boring machine to form a fine groove having a depth of 15 μm in the circumferential direction of the plain bearing. Thereafter, cutting is applied to the bearing central portion by a broach blade, so that the roughness of the bearing alloy surface of the central portion is 0.8 μm Rz. The area of the fine groove in the circumferential direction of the plain bearing is a 30° area from the mating surfaces at both ends of the bearing.

In example 3, the groove depth is formed so as to be continuously shallower such that the circumferential fine groove at the end portion by boring has a depth of 10 μm at the bearing mating surface and has a depth of 1 μm at the position at 30° from the mating surface, as compared to example 1.

In comparative example 1, first, the multi-layer slide member in which the Al alloy bearing is formed on steel is cut into the flat plate having the predetermined dimension. Then, it is formed into a half-bearing formation by press working. Then, chamfering is applied to the outer circumference and the inner circumference of both ends in the width direction of the bearing. Then, it is cramped with a jig, and turning is applied to the entire surface of the bearing inner circumferential surface by a boring machine to form a fine groove having a depth of 4 μm in the circumferential direction of the plain bearing.

In comparative example 2, first, the multi-layer slide member in which the Al alloy bearing is formed on steel is cut into the flat plate having the predetermined dimension. Then, it is formed into a half-bearing formation by press working. Then, chamfering is applied to the outer circumference and the inner circumference of both ends in the width direction of the bearing. Then, it is cramped with a jig, and cutting is applied to the entire surface of the bearing inner circumferential surface by a broaching machine, so that the roughness is 0.8 μm Rz.

In comparative example 3, first, the multi-layer slide member in which the Al alloy bearing is formed on steel is cut into the flat plate having the predetermined dimension. Then, it is formed into a half-bearing formation by press working. Then, chamfering is applied to the outer circumference and the inner circumference of both ends in the width direction of the bearing. Then, the bearing is cramped with a jig, and turning is applied to the bearing end portion by a boring machine to form a fine groove having a depth of 5 μm in the circumferential direction of the plain bearing. Thereafter, cutting is applied to the bearing central portion by the broach blade, so that the roughness of the bearing alloy surface at the central portion is 2 μm Rz. The area of the fine groove in the circumferential direction of the plain bearing is an area of 30° from the mating surface at both ends of the bearing.

Table 2 shows the friction wear test result by the dynamic load bearing testing machine of above described examples 1 to 3 and comparative examples 1. to 3 under the aforementioned conditions. The wear amount is the result of measuring the thickness difference of the bearing central portion before and after the test, and -the alloy fatigue result judges presence or absence of fatigue depending on whether or not a crack is observed on the bearing alloy surface after the test by dye check.

TABLE 2

| | WEAR | PRESENCE OR ABSENCE OF |
|---|---|---|
| | AMOUNT(μm) | ALLOY FATIGUE |
| EXAMPLE 1 | 0.7 | ABSENCE |
| EXAMPLE 2 | 0.8 | ABSENCE |
| EXAMPLE 3 | 0.4 | ABSENCE |
| COMPARATIVE | 3.5 | PRESENCE |
| EXAMPLE 1 | | |
| COMPARATIVE | 3 | ABSENCE |
| EXAMPLE 2 | | |
| COMPARATIVE | 2.5 | ABSENCE |
| EXAMPLE 3 | | |

In examples 1 and 2, the wear amount is small since a favorable oil film is formed due to an oil feeding effect to the bearing central portion by providing the circumferential fine grooves in the bearing end portions by boring, and a flattening effect by applying broaching to the bearing central portion, and the fatigue resistance is high due to the work hardening of the bearing alloy at the bearing central portion by broaching.

In example 3, the wear amount is small by more favorable oil film formation due to a further enhanced oil feeding effect to the bearing central portion since the circumferential fine groove at the end portion becomes continuously thin toward the central portion direction from the end portion. Further, as with the case of examples 1 and 2, the fatigue resistance is high due to work hardening of the bearing alloy of the bearing central portion by broaching.

In comparative example 1 provided with the circumferential fine groove at the bearing central portion, since the roughness of the bearing surface is larger than the oil film thickness, and the top of the projected portion forming the fine groove directly contacts the shaft, the wear amount becomes large. Further, since the work hardening of the alloy did not occur like the broaching since the bearing central portion is due to the boring, the bearing central portion is inferior in fatigue resistance.

In comparative example 2, the wear amount is large since the oil feeding effect to the bearing central portion by the circumferential fine groove by end boring of example 1 is obtained and a favorable oil film is not formed.

In comparative example 3, since the roughness of the bearing central portion is made 2 μm Rz which Is comparative rough, and flattening is insufficient, a favorable oil film is not formed, and the wear amount is large.

The plain bearing 1 described above is described with respect to the one which supports a crankshaft or the like of an automobile engine as one example of its use, but may be used for another internal combustion engine or the like without being limited to the automobile engine.

1. A plain bearing of a half-bearing shape adapted to be combined with another plain bearing to configure a cylindrical shapes comprising:
a primary load portion in the center in a circumferential direction of the plain bearing for mainly receiving load during rotation of a shaft; and
light load portions on both sides of the primary load portion in the circumferential direction of the plain bearing for receiving load smaller than that received by the primary load portion, each light load portion extending in the circumferential direction from a bearing mating surface toward the center by at least 10° and at most 60°, wherein
an inner surface of the primary load portion is worked by broaching so as to have a roughness of 1 μm Rz or less and have a hardness greater than that of the light load portions due to work hardening, and
an inner surface of each light load portion is worked so as to have a circumferential fine groove of a depth of 1 to 15 μm therein.

2. The plain bearing according to claim 1, wherein the depth of the circumferential fine groove gradually decreases toward the center from the bearing mating surface.

3. The plain bearing according to claim 1, wherein the inner surface of each light load portion is worked by boring.

4. A method of manufacturing a plain bearing of a half-bearing shape adapted to be combined with another plain bearing to configure a cylindrical shape, including the steps of:
press-working a multi-layer slide member so as to form a half-bearing formation;
working an inner surface of the slide member by broaching to form a primary load portion in the center in a circumferential direction of the plain bearing for mainly receiving load during rotation of a shaft so that the inner surface of the primary load portion has a roughness of 1 μm Rz or less and is hardened due to work hardening; and
working an inner surface of the slide member by boring to form light load portions on both sides of the primary load portion in the circumferential direction of the plain bearing for receiving load smaller than that received by the primary load portion so that each light load portion extends in the circumferential direction from a bearing mating surface toward the center by at least 10° and at most 60°, and the inner surface of each light load portion has a circumferential fine groove of a depth of 1 to 15 μm.
